(19) United States
(12) Patent Application Publication
(10) Pub. No.: US 2022/0076255 A1
(43) Pub. Date: Mar. 10, 2022

(54) METHODS, SYSTEMS, APPARATUSES, AND DEVICES FOR FACILITATING SECURE PAYMENT TRANSACTIONS BETWEEN USERS

(71) Applicants: Michael Arnold, Miller Place, NY (US); Ariel Scroggins, Atlanta, GA (US)

(72) Inventors: Michael Arnold, Miller Place, NY (US); Ariel Scroggins, Atlanta, GA (US)

(21) Appl. No.: 17/472,409

(22) Filed: Sep. 10, 2021

Related U.S. Application Data
(60) Provisional application No. 63/076,627, filed on Sep. 10, 2020.

(51) Int. Cl. G06Q 20/40

(52) U.S. Cl. CPC G06Q 20/40

(57) ABSTRACT

Disclosed herein is a system for facilitating secure payment transactions between users. Further, a first service provider communication device receives a first user authorization request and a second service provider authorization match response and transmits a first service provider authorization notification and a first user authorization response. Further, a first service provider processing device analyzes the first user authorization request and generates the first service provider authorization notification and the first user authorization response. Further, a second service provider communication device receives a second user authorization request and the first service provider authorization notification and transmits the second service provider authorization match response and a second user authorization response. Further, a second service provider processing device analyzes the second user authorization request and the first service provider authorization notification, generates the second service provider authorization match response for authenticating a payment transaction, and generates the second user authorization response.

The current application claims a priority to the U.S. Provisional Patent application Ser. No. 63/076,627 filed on Sep. 10, 2020.

### FIELD OF THE INVENTION

Generally, the present disclosure relates to the field of data processing. More specifically, the present disclosure relates to methods, systems, apparatuses, and devices for facilitating secure payment transactions between users.

### BACKGROUND OF THE INVENTION

Digital wallet refers to an electronic device, online service, or software program that allows one party to make electronic transactions with another party bartering digital currency units for goods and services. Digital Wallet in this context has a broad definition and includes such instruments as Mobile Banking Applications and Mobile Wallet Applications. These and other applications are not excluded from participating in the payments network that the present invention defines and facilitates.

Many digital wallets are becoming quite popular across the world. However, conventional payment networks require digital wallets use data related to the identity of the consumers which makes them risky for the customers, merchants, and financial institutions. To avoid this risk, Digital Wallet providers and users are restricted to a “Closed Loop” solution. A “Closed Loop” solution is defined as one where the Digital Wallet user can only perform transactions at merchant locations operated by the Digital Wallet provider. This “Closed Loop” restriction prevents Digital Wallet acceptance at all merchants universally. The inability for merchants to accept, and likewise a consumer to use, a Digital Wallet as a legitimate payments mechanism is a significant barrier to widespread adoption and use. Likewise, it is a significant inhibitor of commerce that would otherwise benefit merchants and consumers.

Therefore, there is a need for improved methods, systems, apparatuses and devices for facilitating secure payment transactions between users that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a system for facilitating secure payment transactions between users, in accordance with some embodiments. Accordingly, the system may include a first service provider device and a second service provider device. Further, the first service provider device associated with a first service provider may include a first service provider communication device and a first service provider processing device. Further, the first service provider communication device may be configured for receiving a first user authorization request for a payment transaction from a first user device associated with a first user. Further, the first service provider communication device may be configured for transmitting a first service provider authorization notification to a second service provider device. Further, the first service provider communication device may be configured for receiving a second service provider authorization match response from the second service provider device. Further, the first service provider communication device may be configured for transmitting a first user authorization response to the first user device. Further, the first service provider processing device may be communicatively coupled with the first service provider communication device. Further, the first service provider processing device may be configured for analyzing the first user authorization request. Further, the first service provider processing device may be configured for generating the first service provider authorization notification based on the analyzing of the first user authorization request. Further, the first service provider processing device may be configured for generating the first user authorization response for the payment transaction based on the second service provider authorization match response. Further, the second service provider device associated with a second service provider may include a second service provider communication device and a second service provider processing device. Further, the second service provider communication device may be configured for receiving a second user authorization request for the payment transaction from a second user device associated with a second user. Further, the second service provider communication device may be configured for receiving the first service provider authorization notification from the first service provider device. Further, the second service provider communication device may be configured for transmitting the second service provider authorization match response to the first service provider device. Further, the second service provider communication device may be configured for transmitting a second user authorization response to the second user device. Further, the second service provider processing device may be communicatively coupled with the second service provider communication device. Further, the second service provider processing device may be configured for analyzing the second user authorization request and the first service provider authorization notification. Further, the second service provider processing device may be configured for generating the second service provider authorization match response for authenticating the payment transaction based on the analyzing of the second user authorization request and the first service provider authorization notification. Further, the second service provider processing device may be configured for generating the second user authorization response for the payment transaction based on the second service provider authorization match response.

Further disclosed herein is a system for facilitating secure payment transactions between users, in accordance with some embodiments. Accordingly, the system may include a first service provider device and a second service provider device. Further, the first service provider device associated with a first service provider may include a first service provider communication device and a first service provider processing device. Further, the first service provider communication device may be configured for receiving a first user authorization request for a payment transaction from a first user device associated with a first user. Further, the first service provider communication device may be configured for transmitting a first service provider authorization notification to a second service provider device. Further, the first service provider communication device may be configured for receiving a second service provider authorization match response from the second service provider device. Further, the first service provider communication device may be configured for transmitting a first user authorization response to the first user device. Further, the first service provider processing device may be communicatively coupled with the first service provider communication device. Further, the first service provider processing device may be configured for analyzing the first user authorization request. Further, the first service provider processing device may be configured for generating the first service provider authorization notification based on the analyzing of the first user authorization request. Further, the first service provider processing device may be configured for generating the first user authorization response for the payment transaction based on the second service provider authorization match response. Further, the second service provider device associated with a second service provider may include a second service provider communication device and a second service provider processing device. Further, the second service provider communication device may be configured for receiving a second user authorization request for the payment transaction from a second user device associated with a second user. Further, the second service provider communication device may be configured for receiving the first service provider authorization notification from the first service provider device. Further, the second service provider communication device may be configured for transmitting the second service provider authorization match response to the first service provider device. Further, the second service provider communication device may be configured for transmitting a second user authorization response to the second user device. Further, the second service provider processing device may be communicatively coupled with the second service provider communication device. Further, the second service provider processing device may be configured for analyzing the second user authorization request and the first service provider authorization notification. Further, the second service provider processing device may be configured for determining a match between the second user authorization request and the first service provider authorization notification based on the analyzing of the second user authorization request and the first service provider authorization notification. Further, the second service provider processing device may be configured for generating the second service provider authorization match response for authenticating the payment transaction based on the analyzing of the second user authorization request and the first service provider authorization notification and the determining of the match. Further, the second service provider processing device may be configured for generating the second user authorization response for the payment transaction based on the second service provider authorization match response.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a system for facilitating secure payment transactions between users, in accordance with some embodiments.

FIG. 3 is a block diagram of the system with the first service provider storage device, in accordance with some embodiments.

FIG. 4 is a block diagram of the system with the first user device and the second user device, in accordance with some embodiments.

FIG. 5 is a block diagram of a system for facilitating secure digital payments transactions, in accordance with some embodiments.

FIG. 6 is a flow diagram of a method for authenticating transactions when a merchant generates a QR code, in accordance with some embodiments.

FIG. 7 is a flow diagram of a method for authenticating transactions when a consumer generates a QR code, in accordance with some embodiments.

FIG. 8 is a flow diagram of a method for authenticating websites transactions, in accordance with some embodiments.

FIG. 9 is a flow diagram of a method for registering customers for LRD programs, in accordance with some embodiments.

FIG. 10 is a flow diagram of a method for providing the LRD Programs as part of a transaction, in accordance with some embodiments.

FIG. 11 is a flow diagram of a method for providing the LRD Programs as part of a settlement, in accordance with some embodiments.

FIG. 12 illustrates a first data dictionary of PayDN, in accordance with some embodiments.

FIG. 13 illustrates a second data dictionary of the PayDN, in accordance with some embodiments.

FIG. 14 is a block diagram of a system for facilitating secure payment transactions between users, in accordance with some embodiments

FIG. 15 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods, systems, apparatuses, and devices for facilitating secure payment transactions between users, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer, etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor, etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data, and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The present disclosure describes methods, systems, apparatuses, and devices for facilitating secure payment transactions between users.

Further, the present disclosure describes a system for facilitating secure digital payments transactions. The system may be configured to execute a number of sample purchases and show the results of the process in both a Consumer and Merchant dashboard. The sample purchases may be simple demonstrations of different combinations of SKU, Quantity, and Cost so that the data has a realistic context. Further, one of those samples may constitute a payment authorization decline.

Further, the system may be configured to use QR Codes, APIs, and Dashboards and may have the appropriate level of integration to demonstrate technical feasibility. The system may be configured to handle heavy burdens like encryption, key management, authentication, transaction timeout, transaction routing. These elements may be layered into the minimum viable product.

Further, the present disclosure describes a method for authenticating transactions when a merchant generates a QR code. First, a Merchant POS (including Virtual POS devices and eCommerce websites, hereafter referred to simply as POS) may generate QR Codes. For example, the Merchant POS may generate QR Codes that are digitally signed, cryptographically secure, have a limited time to live (are single use), and contain a shared secret or correlation ID, details about the merchant, and the actual transaction. It should be noted here that although the embodiments focus on QR Codes the present invention is not restricted or limited to only QR Codes as the method for data exchange between the Consumer App and the Merchant POS. Technologies like Near Field Communication or NFC, Bluetooth, and others are relevant and applicable for this discussion. Then, a Consumer Mobile App may scan the Merchant QR Code, display pertinent details to the user, and allow the user to Pay by entering a credential (PIN) and clicking an Accept option. Then, the Consumer Mobile App may POST a Consumer Auth Request API to their Digital Wallet Provider and wait for a response. Further, the Merchant POS may POST a Merchant Auth Request API to PayDN the merchant Digital Wallet acquirer, and wait for a response. Then, a Digital Wallet (hereafter referred to simply as DW) Partner Application may accept the Auth Request from the Consumer Mobile App and POST an Authorization Notification to a PayDN Authorization Front End (hereafter referred to simply as Auth FE). Further, the PayDN Auth FE (described in detail below) may accept the Auth Request from the Merchant POS and wait for the Auth Notification from the Auth Notification service. Upon receipt of the Auth Notification, the Auth Response may be returned to the Merchant POS and to the DW Partner (described in detail below) via the PayDN Auth Match Response. Further, the results of the Authorization Requests may be displayed on both the Consumer Mobile App and the Merchant POS.

Further, the present disclosure describes a method for authenticating transactions when a consumer generates a QR code. First, a Consumer Mobile App may generate QR codes. For example, the Consumer Mobile App may generate QR codes that are digitally signed, cryptographically secure, have a limited time to live (are single use), and contain a shared secret or correlation ID, a hashed user credential, and other transaction details. It should be noted here that although the embodiments focus on QR Codes the present invention is not restricted or limited to only QR Codes as the method for data exchange between the Consumer App and the Merchant POS. Technologies like Near Field Communication or NFC, Bluetooth, and others are relevant and applicable for this discussion. Then, a Merchant POS may scan the Consumer QR Code and display the option to Authorize the transaction. Further, the Consumer Mobile App may POST a Consumer Auth Request API to the Digital Wallet Provider and wait for a response. Further, the Merchant POS may POST a Merchant Auth Request API to PayDN (the merchant Digital Wallet acquirer) and wait for a response. Further, a PayDN Auth FE (described in detail below) may accept the Auth Request from the POS and POST an Authorization Notification to the DW Provider. Further, a DW Provider may accept the Auth Request from the Consumer Mobile App and wait for the Auth Notification from PayDN. Upon receipt of the Auth Notification, the Auth Response may be returned to the Consumer Mobile App and to the PayDN via the DW Partner Auth Match Response. Further, the results of the Authorization Requests may be displayed on both the Consumer Mobile App and the Merchant POS.

The disclosed system does not rely on track 2 (PCI) data to execute transactions. Further, the disclosed system is more secure as it uses a secure hash (single use tokens) to execute transactions. The secure hash includes confirmation from a customer about agreeing to pay a certain amount to a merchant. Further, the transaction is approved only if a request from merchant POS matches a request from a customer mobile application. Further, the system may approve a transaction only if the geolocation of merchant POS matches with the geolocation of the customer's mobile device, in the case of Brick and Mortar payment transactions. Additional security techniques are applied to each transaction type. Further, the customer mobile application may use a salt added during cryptography which may employ PIN/biometric data used for unlocking the customer mobile device. Further, the disclosed system uses merchant POS software designed to accept/generate QR codes and authenticate transactions with PayDN. Further, the disclosed system may be easily integrated by merchants as PayDN (the acquirer) establishes a single transaction and operational standard for all parties. Further, the disclosed system is configured to coordinate three distinct trust domains—between DW provider and DW users, between PayDN and the merchant, and between PayDN and DW providers. Further, the disclosed system provides a single platform to multiple DWs and allows DWs to be used for open loop payments. By “Open Loop” payments we mean broad acceptance of any PayDN certified and compliant DW application at any PayDN certified and compliant merchant location and POS.

Further, the present disclosure describes a Multi-Party Synchronous Authorization Network (MPSA) for facilitating secure digital payments transactions. The MPSA network relies on 3 distinct zones of trust to ensure each transaction conforms to predefined standards. The standards may be set by Payment Data Network (PayDN). The first trust zone exists between the buyer/customer and the issuer/wallet provider. The second trust zone exists between the merchant/seller and PayDN and the second trust zone exists between PayDN and issuer/wallet provider. The focus is on validating the transaction and not the consumer, because of that, no consumer or payment information is required or allowed to be used on the network. All transactions are settled through PayDN's acquiring bank. The issuer/wallet provider who already knows the customer authenticates and vouches for the customer without having to disclose who is that customer.

PayDN authenticates the merchant as well as the ancillary service provider and warrants all transactions originating from those entities.

During purchase, the customer approves the purchase amount based on the conditions set by the issuer/wallet provider.

Further, the present disclosure describes a method for authenticating transactions when a merchant generates a QR code. First, a Merchant POS may generate QR Codes. For example, the Merchant POS may generate QR Codes that are digitally signed, cryptographically secure, have a limited time to live (are single use), and contain a shared secret or correlation ID, details about the merchant, and the actual transaction. Then, a Consumer Mobile App may scan the Merchant QR Code, display pertinent details to the user, and allow the user to Pay by entering a credential (PIN) and clicking an Accept option.

Then, the Consumer Mobile App may POST to the Consumer Auth Request API and wait for a response.

Further, the Merchant POS may POST to the Merchant Auth Request API and wait for a response.

Then, a Digital Wallet (DW) Partner Application may accept the Auth Request from the Consumer Mobile App and POST an Authorization Notification to a PayDN Auth FE.

Further, the PayDN Auth FE (described in detail below) may accept the Auth Request from the Merchant POS and wait for the Auth Notification from the Auth Notification service.

Upon receipt of the Auth Notification, the Auth Response may be returned to the Merchant POS and to the DW Partner (described in detail below) via the PayDN Auth Match Response.

Further, the results of the Authorization Requests may be displayed on both the Consumer Mobile App and the Merchant POS.

Further, it may be noted that in this case, the Consumer has all of the objects in the transaction. Therefore, the Auth Notification comes from the DW Partner into PayDN so that matching can take place. For example, the DW Partner may put their Auth Response in the message so that a second “back and forth” to get to the Auth Response can be eliminated. The information about Success or Failure may be provided in the PayDN Auth Match Notification and the DW Provider may take necessary action and perform final disposition of the auth request.

According to some embodiments, eCommerce transactions as well as Brick and Mortar transactions are supported natively by the disclosed solution. PayDN can integrate with merchant eCommerce sites or host directly. However, this transaction context may also support the use of a simple transaction code (short string) instead of a QR code to simplify the user experience.

Further, the present disclosure describes a method for authenticating transactions when a consumer generates a QR code. First, a Consumer Mobile App may generate QR codes For example, the Consumer Mobile App may generate QR codes that are digitally signed, cryptographically secure, have a limited time to live (are single use), and contain a shared secret or correlation ID, a hashed user credential and other transaction details.

Then, a Merchant POS may scan the Consumer QR Code and display the option to Authorize the transaction.

Further, the Consumer Mobile App may POST to the Consumer Auth Request API and wait for a response.

Further, the Merchant POS may POST to the Merchant Auth Request API and wait for a response.

Further, a PayDN Auth FE (described in detail below) may accept the Auth Request from the POS and POST an Authorization Notification to the DW Provider.

Further, a DW Provider may accept the Auth Request from the Consumer Mobile App and wait for the Auth Notification from PayDN.

Upon receipt of the Auth Notification, the Auth Response may be returned to the Consumer Mobile App and the PayDN via the DW Partner Auth Match Response.

Further, the results of the Authorization Requests may be displayed on both the Consumer Mobile App and the Merchant POS.

It may be noted that in this case, the Merchant has all of the objects in the transaction, and therefore the Auth Notification comes from PayDN into the DW Partner (described in detail below) so that matching can take place. The information about Success or Failure may be provided in the DW Partner Auth Match Notification and PayDN may take necessary action and perform the final disposition of the auth request.

In some embodiments, a consumer dashboard may be provided, wherein the dashboard may display transaction history. The transaction history display may show all the transactions for any given day. With enough data simple things like spend trends (Number of transactions/Total Spend) over time (Days/Weeks) should be available. Finally, transaction details may be available and show the contents of the Basket that was the basis for that transaction.

In some embodiments, a merchant dashboard may be provided, wherein the dashboard may display transaction history. The transaction history display may show all the transactions for any given day. With enough data simple things like earnings trends (Number of transactions/Total Revenue/Total Costs) over time (Days/Weeks) should be available. Finally, transaction details should be available and show the contents of the Basket that was the basis for that transaction.

According to some embodiments, the system for authenticating payments transactions includes the PayDN Auth FE. The PayDN Auth FE interacts with the Merchant POS and the DW Partner. Fundamentally, this component establishes trust between the Merchant and the Consumer by establishing trust between the Merchant, PayDN, and the DW Partner. The DW Partner extends that trust to the consumer via their Consumer Mobile App.

Further, the PayDN may be a Java application hosted in Tomcat (the same instance as DW Partner). Alternatively, it may be hosted on Apache HTTP or NGNIX HTTP server. The development environment may include Eclipse with the latest JDK/JRE. The application may perform the following functions:

1. Host a listener for the Merchant Auth Request API.

2. The Merchant Auth Request implementation will be a synchronous request/reply. It will listen for the DW Partner Auth Notification API to post a message to a Postgres table. It will pick that up and pass it back as a Merchant Auth Response back to the Merchant POS.

3. Host a Listener for the DW Partner Auth Notification API.

4. The implementation for the DW Partner Auth Notification API will persist the message to a Postgres table that the Merchant Auth Request implementation is listening to.

5. Persist transaction details to a PostgreSQL RDBMS for use by the Merchant Dashboard.

6. Generate and send a Merchant Auth Response

7. Generate and send a PayDN Auth Match Response.

8. Host a web application that is a simple Merchant Dashboard. This may be based on HTML5/CSS3 so that it runs in a native browser on the mobile device and does not require special mobile app development to consume and render.

According to some embodiments, the system for authenticating payments transactions includes the DW Partner platform. The DW Partner platform interacts with the Consumer and PayDN. Fundamentally, this component establishes trust between the Consumer and the Merchant by establishing trust between the Consumer, the DW Partner, and PayDN. The PayDN extends that trust to the merchant via their POS.

The DW Partner application may be a Java application hosted in Tomcat (same instance as PayDN). Alternatively, it may be hosted on an Apache HTTP or NGNIX HTTP server. The development environment may include Eclipse with the latest JDK/JRE. The application may perform the following functions:

1. Host a listener for the Consumer Auth Request API.

2. The Consumer Auth Request implementation will be a synchronous request/reply. That will simply wait for the auth response from the DW Partner.

3. Generate and POST (REST/JSON) a DW Partner Auth Notification.

4. Host a listener for a PayDN Auth Match Response.

5. Parse the PayDB Auth Match Response.

6. Persist transaction details to a PostgreSQL RDBMS for use by the Consumer Dashboard.

7. Generate and send a Customer Auth Response

8. Host a web application that is a simple Consumer Dashboard. This may be based on HTML5/CSS3 so that it runs in a native browser on the mobile device and does not require special mobile app development to consume and render.

According to some embodiments, the system for authenticating payments transactions includes one or more databases. The system may be configured to create schemas, tables, indexes, and referential integrity needed to support the Consumer and Merchant Dashboard requirement in the databases.

Further, the tables needed for the prototype may match 1:1 with the JSON Object Model for simplicity's sake. Further, foreign keys may be added to facilitate the dashboard's provision.

Further, the tables may include one or more of:

1. Buyer Table—This holds basic information about the Seller.

2. Seller Table—This holds basic information about the Merchant.

3. Transaction Table—This holds basic information about the Transaction including the Auth Response (the “response” object from JSON).

4. Basket Table—This table holds the Basket details for each transaction

5. Taxes Table—This table holds the Tax details for each transaction.

According to some embodiments, the system for authenticating payments transactions may include one or more Mobile App, Virtual POS (SDK), PayDN Auth FE, DW Partner, and Reporting Dashboard (details below).
Mobile App
Eclipse IDE
Latest JDK/JRE
Android Development Toolkit Plugin
Gradle for build
GITHUB repo
Virtual POS (SDK)
Eclipse IDE
Latest JDK/JRE
Android Development Toolkit Plugin
Gradle for build
GITHUB repo
PayDN Auth FE
Eclipse IDE
Latest JDK/JRE
Gradle for build
GITHUB repo
SpringBoot
Swagger
DW Partner
Eclipse IDE
Latest JDK/JRE
Gradle for build
GITHUB repo
SpringBoot
Swagger
Reporting Dashboard
Eclipse IDE
Latest JDK/JRE
Gradle for build
GITHUB repo
SpringBoot
Angular.js/React.js

According to some embodiments, the system for authenticating payments transactions employs six APIs (listed below).
Consumer (Buyer) Auth Request/Response
Merchant (Seller) Auth Request/Response
DW Partner Auth Notification
PayDN Auth Match Notification
PayDN Auth Notification
DW Partner Auth Match Notification

According to some embodiments, the system for authenticating payments transactions may be configured to generate QR codes. The simplest way to communicate the contents of the QR Codes that will be used in this application is with JSON. It may be required to first stringify the JSON so that it can be placed in the QR Code. Something like this: JSON.stringify(json).

When reading the QR Code, it may be required to parse the string to get back to JSON. Something like this: JSON.parse(str).

It is best practice to compress the JSON first especially since the “basket” object can potentially be large. Further, the jsonpack library may be used to do this. It claims to compress it up to 55%.

The QR Codes and other data elements will have to be signed, encrypted, and hashed for the MVP (Minimal Viable Product). The QR Codes may be described as:

{

“type”: “QRPayload”,
“properties”:{

“consumer”:{

“token”: {“type”: “string”},
“app”: {“type”: “string”},
“currency”: {“type”: “string”},
“currency”: {“type”: “string”},
“discount”: [{

“provider”: {“type”: “string”},
“category”: {“type”: “string”},
“amount”: {“type”: “number”}

}],
“geolocation”: {“type”: “string”},

“transaction”:}

“category”: {“type”: “string”},
“dba”: {“type”: “string”},
“location”: {“type”: “string”},
“phone”: {“type”: “string”},
“order”: {“type”: “string”},
“token”: {“type”: “string”},
“currency”: {“type”: “string”},
“geolocation”: {“type”: “string”},
},

“basket”: [{

“sku”: {“type”: “number”},
“description”: {“type”: “string”},
“price”: {“type”: “number”},
“quantity”: {“type”: “number”}

}]
“messagesignature”: {“type”: “string”}

}
}

According to some embodiments, the system for authenticating payments transactions may be configured to provide Loyalty, Rewards, and Discount programs (hereafter referred to simply as LRD Programs or just LRD) that the merchant and or the consumer may participate in can be applied to a transaction.

According to some embodiments, there may be two primary use cases when considering how LRD Programs will be injected into the PayDN transaction flow.

Accordingly, the first use case may be related to providing LRD Programs that are incorporated into the transaction in real time. The second use case may be related to providing LRD Programs as part of the transaction settlement process or not in real time.

Further, it is important to note that even if the LRD is applied to the transaction in real time, the Consumer is the one who is realizing that benefit immediately. Depending on the terms of the LRD Program, there may be a need for the PayDN Settlement process to recoup funds from the LRD Program sponsor in order to make the Merchant whole at the end of the business day. So there may always be a Settlement component for the implementation of an LRP Program.

However, to enable either of these use cases there may be an initial use case whereby the Consumer must register their participation with a specific LRD Program with PayDN. This is necessary to facilitate the interaction and maintain the principles of PayDN (Simple, Secure, and Private). As is the case with all interactions, PayDN knows nothing about the particular consumer. The registration process may allow PayDN to extend the Trust Domain that it has with the DW Provider out to the LRD Program Sponsor. Once this Trust Domain is established and a secure token identifier is established for the Consumer that can be effectively shared between the Trust Domain Parties (DW Provider/PayDN/LRD Sponsor) transactions can securely and reliably flow across the network.

Further, the present disclosure describes a method for PayDN LRD Program Consumer Registration. The method may include one or more following steps:

1. The consumer will go to their DW Provider website and register the LRD Programs that they are participating in and who are certified on the PayDN Payment Data Network

2. The DW Provider will use PayDN APIs to create a unique token identifier for the Consumer that all parties in the transaction will know.

3. The DW Provider will keep a mapping of these values for their user so that they can be added on transaction payloads as needed in the future.

4. PayDN will integrate with each LRD Program Sponsor as needed to set up this user under this secure token. The LRD Program Sponsor will map the user token to their account so they can be identified later on and the correct program benefit can be applied.

5. PayDN will proxy this registration process only. PayDN does not store Consumer information of any kind

Further, PayDN acts as a proxy for this registration process between the DW Provider and the LRD Program Sponsor. Both entities need to be certified on the PayDN Payment Data Network for this process to work. PayDN offers a single standard way for multiple DW Providers to interact with multiple LRD Program Sponsors thus ensuring rapid time to market, broad reach across LRD Program Sponsors, and a simple process to support. Likewise, PayDN provides similar benefits to LRD Program Sponsors giving the broad reach across DW Providers and so on.

Further, the present disclosure describes a method for providing LRD Programs as part of a Transaction. The method may include one or more following steps:

1. Consumer will perform a transaction on their PayDN certified DW Application at a PayDN certified merchant.

2. The Consumer and/or the DW Provider can inject into the Authorization Request data payload information about applicable LRD Programs and the Token Identifier for that Consumer within each program.

3. PayDN Authorization Front End will link to each LRD Program Sponsor with details about the transaction like the information in the Basket requesting that the LRD Program Sponsor respond accordingly. This response could be a simple Yes/No that the Loyalty was applier or a discounted amount or a discounted percent on the transaction that can be applied immediately.

4. PayDN will take the necessary steps to update the transaction accordingly and respond to the Merchant and the DW Provider in kind.

It may be noted that in some respects elements of the transaction that just happened may have additional steps that will happen as part of a settlement. For example, if the Merchant is to be provided the amount of a Coupon Discount from a Consumer Goods Manufacturer then this would happen as part of the settlement process.

Further, the present disclosure describes a method for providing LRD Programs as part of Settlement. The method may include one or more following steps:

1. Incoming—This is where all of the transactions processed on the Payment Data Network for a given period of time are prepared for settlement.

2. Adjustments—This is where all of the transactions that need to or have had an adjustment applied to them are prepared for settlement. Adjustments can come from PayDN internal processes like Reconciliation or from external processes like LRD Programs. They can also be the result of things like DCC that may occur as part of the transaction.

3. Outgoing—This is where all financial information that has been processed for a given time period needs to be sent to various institutions. These institutions could simply be looking for reporting data or they may actually be moving funds across accounts like the Fed via NACHA. Regardless of the purpose, this is where all outgoing file processing is handled.

4. Reconciliation—This is where all accounts are balanced and the financials are closed on a given settlement time period. Financial period reporting is updated (Daily, Weekly, Monthly, and so on).

5. Posting—This is where the General Ledger of Accounts is updated so that the financial position of PayDN is known.

6. File Transmission—This is where all incoming and outgoing file transmissions are managed. SLAs are monitored, operational alerts are sent and the secure configuration of all connections with other entities is established.

As part of the LRD Program integration, there will be files exchanged between many entities and PayDN to reconcile the administration of these programs and to move money or other elements of value (ie. Points) across entities that are responsible for the same.

The value proposition to DW Providers and LRD Program sponsors are:

1. A single integration standard to learn, implement and maintain

2. Broad reach across a large ecosystem of PayDN Certified DW Providers and LRD Program Sponsors.

3. Single reconciliation and reporting solution

4. Engagement with the Consumer at the transaction level building brand awareness, differentiation, and loyalty.

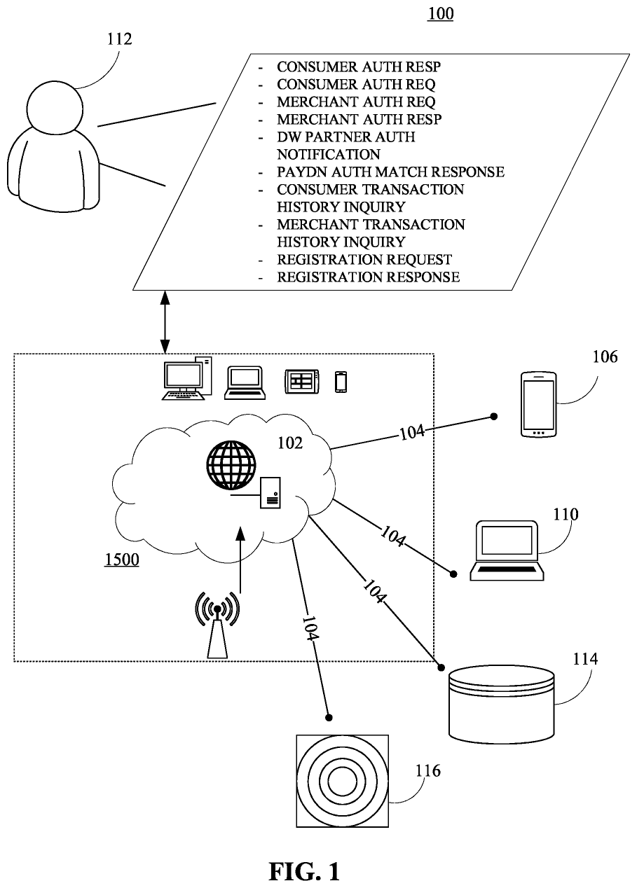

FIG. 1 is an illustration of an online platform 100 consistent with various embodiments of the present disclosure. By way of non-limiting example, the online platform 100 to facilitate secure payment transactions between users may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 1500.

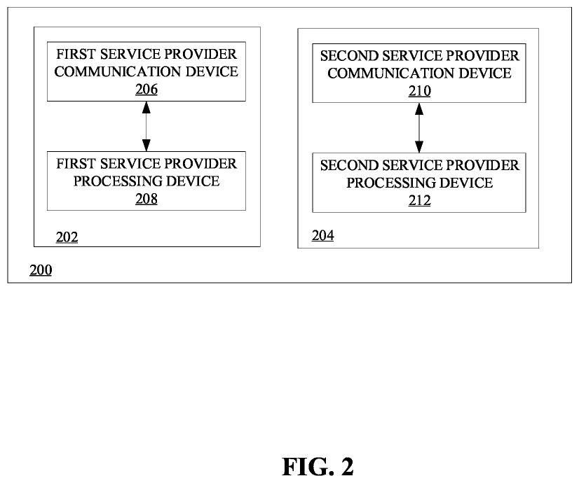

FIG. 2 is a block diagram of a system 200 for facilitating secure payment transactions between users, in accordance with some embodiments. Accordingly, the system 200 may include a first service provider device 202 and a second service provider device 204.

Further, the first service provider device 202 associated with a first service provider may include a first service provider communication device 206 and a first service provider processing device 208. Further, the first service provider may include a DW partner.

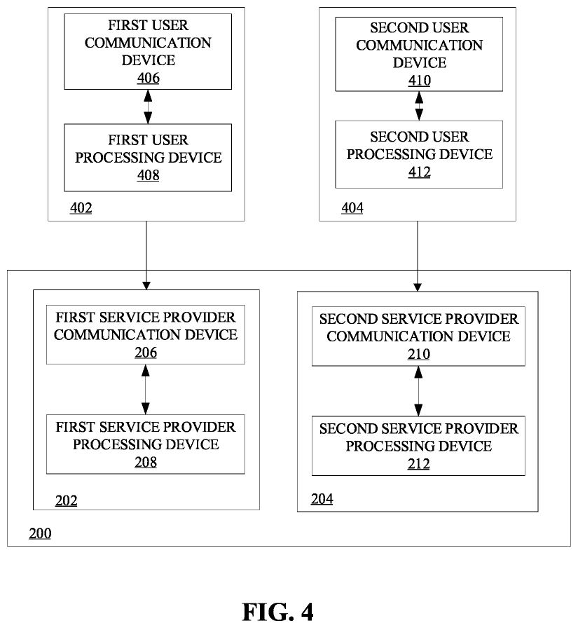

Further, the first service provider communication device 206 may be configured for receiving a first user authorization request for a payment transaction from a first user device 402, as shown in FIG. 4, associated with a first user. Further, the first service provider communication device 206 may be configured for transmitting a first service provider authorization notification to a second service provider device 204. Further, the first service provider communication device 206 may be configured for receiving a second service provider authorization match response from the second service provider device 204. Further, the first service provider communication device 206 may be configured for transmitting a first user authorization response to the first user device 402. Further, the first service provider processing device 208 may be communicatively coupled with the first service provider communication device 206. Further, the first service provider processing device 208 may be configured for analyzing the first user authorization request. Further, the first service provider processing device 208 may be configured for generating the first service provider authorization notification based on the analyzing of the first user authorization request. Further, the first service provider processing device 208 may be configured for generating the first user authorization response for the payment transaction based on the second service provider authorization match response.

Further, the second service provider device 204 associated with a second service provider may include a second service provider communication device 210 and a second service provider processing device 212. Further, the second service provider may be a PayDN.

Further, the second service provider communication device 210 may be configured for receiving a second user authorization request for the payment transaction from a second user device 404, as shown in FIG. 4, associated with a second user. Further, the second service provider communication device 210 may be configured for receiving the first service provider authorization notification from the first service provider device 202. Further, the second service provider communication device 210 may be configured for transmitting the second service provider authorization match response to the first service provider device 202. Further, the second service provider communication device 210 may be configured for transmitting a second user authorization response to the second user device 404. Further, the second service provider processing device 212 may be communicatively coupled with the second service provider communication device 210. Further, the second service provider processing device 212 may be configured for analyzing the second user authorization request and the first service provider authorization notification. Further, the second service provider processing device 212 may be configured for generating the second service provider authorization match response for authenticating the payment transaction based on the analyzing of the second user authorization request and the first service provider authorization notification. Further, the second service provider processing device 212 may be configured for generating the second user authorization response for the payment transaction based on the second service provider authorization match response.

Further, in some embodiments, the first user device 402 may include a first user communication device 406, as shown in FIG. 4, and a first user processing device 408, as shown in FIG. 4. Further, the first user communication device 406 may be configured for receiving a payment transaction code for the payment transaction from the second user device 404. Further, the payment transaction code may include a QR code, a NFC code, a Bluetooth code, etc. Further, the first user communication device 406 may be configured for transmitting at least one payment information to at least one first output device. Further, the first user communication device 406 may be configured for receiving a first user acknowledgment from at least one first input device. Further, the first user communication device 406 may be configured for transmitting the first user authorization request to the first service provider device 202. Further, the first user processing device 408 may be communicatively coupled with the first user communication device 406. Further, the first user processing device 408 may be configured for analyzing the payment transaction code. Further, the first user processing device 408 may be configured for generating the at least one payment information of the payment transaction based on the analyzing of the payment transaction code. Further, the first user processing device 408 may be configured for generating the first user authorization request based on the analyzing of the payment transaction code and the first user acknowledgment.

Further, in an embodiment, the second user device 404 may include a second user communication device 410, as shown in FIG. 4, and a second user processing device 412, as shown in FIG. 4. Further, the second user communication device 410 may be configured for receiving at least one payment transaction information associated with the payment transaction from at least one second input device. Further, the second user communication device 410 may be configured for transmitting the payment transaction code to the first user device 402. Further, the second user processing device 412 may be communicatively coupled with the second user communication device 410. Further, the second user processing device 412 may be configured for analyzing the at least one payment transaction information. Further, the second user processing device 412 may be configured for generating the payment transaction code based on the analyzing of the at least one payment transaction information.

Further, in an embodiment, the second user processing device 412 may be configured for generating the second user authorization request based on the generating of the payment transaction code. Further, the second user communication device 410 may be configured for transmitting the second user authorization request to the second service provider device 204.

Further, in some embodiments, the second service provider processing device 212 may be configured for determining a match between the second user authorization request and the first service provider authorization notification based on the analyzing of the second user authorization request and the first service provider authorization notification. Further, the generating of the second service provider authorization match response may be based on the determining the match.

Further, in some embodiments, the first user device 402 may include at least one first output device. Further, the at least one first output device may be configured for displaying the first user authorization response. Further, the second user device 404 may include at least one second output device. Further, the at least one second output device may be configured for displaying the second user authorization response.

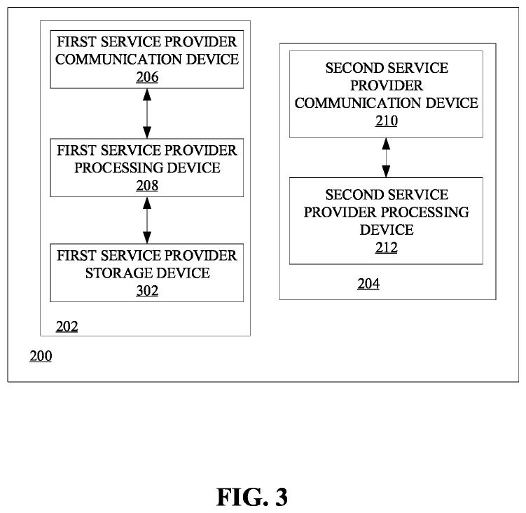

Further, in some embodiments, the first service provider communication device 206 may be configured for receiving at least one benefit program request for availing at least one benefit program (LRD programs) for the payment transaction from the first user device 402. Further, the first service provider communication device 206 may be configured for transmitting at least one unique token identifier associated with the first user to the second service provider device 204. Further, the first service provider processing device 208 may be configured for analyzing the at least one benefit program request. Further, the first service provider processing device 208 may be configured for registering the first user for the at least one benefit program based on the analyzing of the at least one benefit program request. Further, the first service provider processing device 208 may be configured for generating the at least one unique token identifier of at least one token assigned to the first user based on the registering. Further, the first service provider device 202 may include a first service provider storage device 302, as shown in FIG. 3, communicatively coupled with the first service provider processing device 208. Further, the first service provider storage device 302 may be configured for storing the at least one unique token identifier associated with the first user.

Further, in an embodiment, the second service provider communication device 210 may be configured for receiving a plurality of benefit programs provided by a benefit provider (LRD program sponsor) from a benefit provider device associated with the benefit provider. Further, the second service provider communication device 210 may be configured for receiving the at least one unique token identifier from the first service provider device 202. Further, the second service provider communication device 210 may be configured for transmitting the at least one unique token identifier and at least one benefit program notification to the benefit provider device. Further, the second service provider processing device 212 may be configured for analyzing the plurality of benefit programs and the at least one unique token identifier. Further, the second service provider processing device 212 may be configured for identifying at least one benefit program from the plurality of benefit programs needed by the first user corresponding to the at least one token based on the analyzing of the plurality of benefit programs and the at least one unique token identifier. Further, the second service provider processing device 212 may be configured for generating the at least one benefit program notification associated with the at least one benefit program based on the identifying.

Further, in an embodiment, the benefit provider device may include a benefit provider storage device, a benefit provider processing device, and a benefit provider communication device. Further, the benefit provider communication device may be configured for receiving the at least one unique token identifier and the at least one benefit program notification from the second service provider device 204. Further, the benefit provider communication device may be configured for transmitting a registration response to the second service provider device 204. Further, the benefit provider processing device may be communicatively coupled with the benefit provider communication device. Further, the benefit provider processing device may be configured for mapping the at least one token to the at least one benefit program. Further, the benefit provider processing device may be configured for generating the registration response for the first user based on the mapping. Further, the benefit provider storage device may be communicatively coupled with the benefit provider processing device. Further, the benefit provider storage device may be configured for storing the plurality of benefit programs.

Further, in some embodiments, the second service provider processing device 212 may be configured for processing the payment transaction between the first user and the second user based on the authenticating. Further, the second service provider processing device 212 may be configured for generating at least one payment transaction information associated with the payment transaction based on the processing.

Further, in an embodiment, the first user authorization request may include the at least one unique token identifier associated with the first user. Further, the first service provider processing device 208 may be configured for identifying the at least one benefit program appliable to the first user based on the analyzing of the first user authorization request. Further, the first service provider communication device 206 may be configured for transmitting the at least one token and the at least one benefit program to the second service provider device 204. Further, the second service provider communication device 210 may be configured for receiving the at least one token and the at least one benefit program. Further, the second service provider communication device 210 may be configured for transmitting at least one link to the benefit provider device. Further, the second service provider communication device 210 may be configured for receiving at least one response on the at least one link from the benefit provider device. Further, the second service provider processing device 212 may be configured for analyzing the at least one benefit program and the at least one payment transaction information. Further, the second service provider processing device 212 may be configured for establishing the at least one link between the at least one transaction information and the at least one benefit program based on the analyzing of the at least one benefit program and the at least one payment transaction information. Further, the second service provider processing device 212 may be configured for analyzing the at least one response. Further, the second service provider processing device 212 may be configured for updating the payment transaction based on the analyzing of the at least one response.

FIG. 3 is a block diagram of the system 200 with the first service provider storage device 302, in accordance with some embodiments.

FIG. 4 is a block diagram of the system 200 with the first user device 402 and the second user device 404, in accordance with some embodiments.

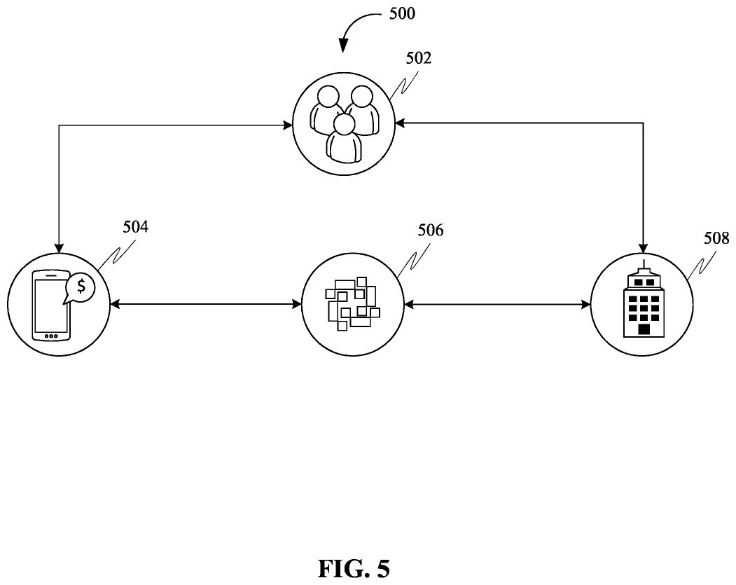

FIG. 5 is a block diagram of a system 500 for facilitating secure digital payments transactions, in accordance with some embodiments. Further, the system 500 may include a consumer 502, a bank/issuer/wallet 504, a Multi-Party Synchronous Authorization (MPSA) network 506, and a merchant 508. Further, the consumer 502 may use a digital wallet mobile app to generates or accept keys. Further, the consumer 502 may view basket details. Further, the consumer 502 may approve final transaction amounts. Further, the bank/issuer/wallet 504 may authenticate a user. Further, the bank/issuer/wallet 504 may transmit the key. Further, the bank/issuer/wallet 504 may accept a basket. Further, the bank/issuer/wallet 504 may transmit an authorization response. Further, the MPSA network 506 may validate & match keys. Further, the MPSA network 506 may authenticate the merchant 508. Further, the MPSA network 506 may accept, store and transmit the basket. Further, the MPSA network 506 may accept, store and transmit the authorization response. Further, the MPSA network 506 may integrate with ancillary services. Further, the MPSA network 506 may provide benefits (coupons, loyalty, rewards, and promotions). Further, the merchant 508 may generate or accept keys.

Further, the MPSA network 506 may transmit the basket. Further, the MPSA network 506 may accept the authorization response. Further, a transaction key (such as A1B2C3D4) may be transmitted between the consumer 502 and the bank/issuer/wallet 504. Further, the transaction key (such as A1B2C3D4) may be transmitted between the consumer 502 and the merchant 508.

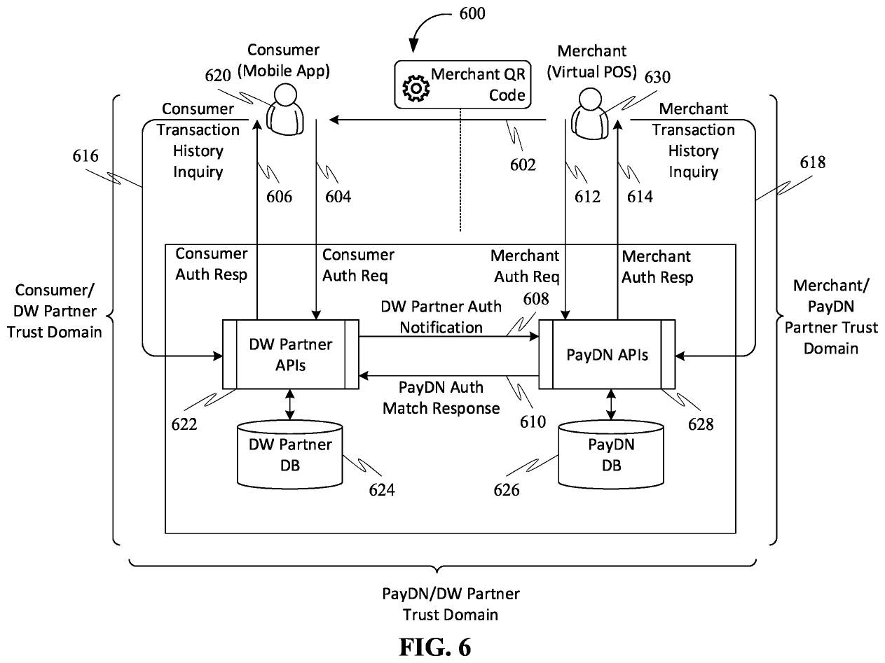

FIG. 6 is a flow diagram of a method 600 for authenticating transactions when a merchant generates a QR code, in accordance with some embodiments. Further, at 602 of the method 600, a consumer 620 (Mobile App) receives a merchant QR code from a merchant 630 (virtual POS). Further, at 604 of the method 600, the consumer 620 may transmit consumer auth req to DW partner APIs 622. Further, at 606 of the method 600, the DW partner APIs 622 may transmit consumer auth resp to the consumer 620. Further, at 608 of the method 600, the DW partner APIs 622 may transmit DW partner auth notification to PayDN APIs 628. Further, at 610 of the method 600, the PayDN APIs 628 may transmit PayDN auth match response to the DW partner APIs 622. Further, at 612 of the method 600, the merchant 630 may transmit merchant auth req to the PayDN APIs 628. Further, at 614 of the method 600, the PayDN APIs 628 may transmit merchant auth resp to the merchant 630. Further, at 616 of the method 600, the consumer 620 may transmit consumer transaction history inquiry to the DW partner APIs 622. Further, at 618 of the method 600, the merchant 630 may transmit merchant transaction history inquiry to the PayDN APIs 628. Further, the DW partner APIs 622 may be communicatively coupled with a DW partner DB 624. Further, the PayDN APIs 628 may be communicatively coupled with a PayDN DB 626.

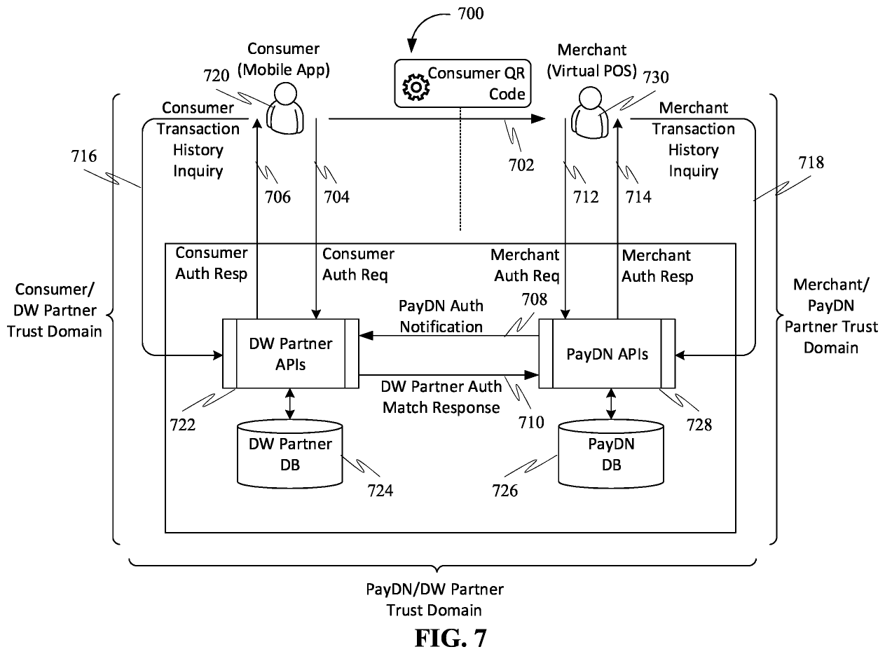

FIG. 7 is a flow diagram of a method 700 for authenticating transactions when a consumer generates a QR code, in accordance with some embodiments. Further, at 702 of the method 700, a consumer 720 (Mobile App) transmits a merchant QR code to a merchant 730 (virtual POS). Further, at 704 of the method 700, the consumer 720 may transmit consumer auth req to DW partner APIs 722. Further, at 706 of the method 700, the DW partner APIs 722 may transmit consumer auth resp to the consumer 720. Further, at 708 of the method 700, the DW partner APIs 722 may transmit DW partner auth notification to PayDN APIs 728. Further, at 710 of the method 700, the PayDN APIs 728 may transmit PayDN auth match response to the DW partner APIs 722. Further, at 712 of the method 700, the merchant 730 may transmit merchant auth req to the PayDN APIs 728. Further, at 714 of the method 700, the PayDN APIs 728 may transmit merchant auth resp to the merchant 730. Further, at 716 of the method 700, the consumer 720 may transmit consumer transaction history inquiry to the DW partner APIs 722. Further, at 718 of the method 700, the merchant 730 may transmit merchant transaction history inquiry to the PayDN APIs 728. Further, the DW partner APIs 722 may be communicatively coupled with a DW partner DB 724. Further, the PayDN APIs 728 may be communicatively coupled with a PayDN DB 726.

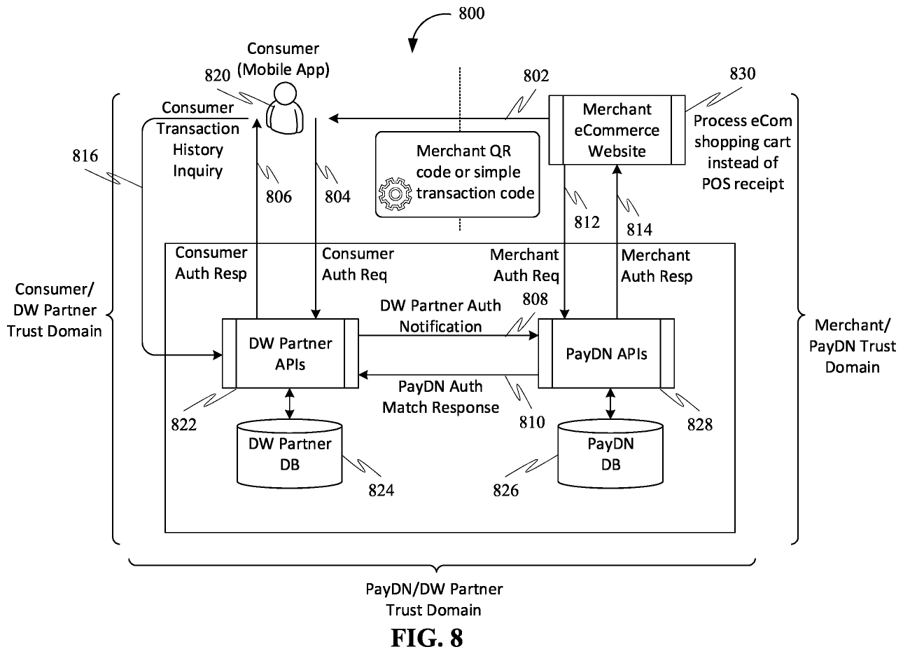

FIG. 8 is a flow diagram of a method 800 for authenticating websites transactions, in accordance with some embodiments. Further, at 802 of the method 800, a consumer 820 (Mobile App) receives a merchant QR code from a merchant eCommerce website 830. Further, at 804 of the method 800, the consumer 820 may transmit consumer auth req to DW partner APIs 822. Further, at 806 of the method 800, the DW partner APIs 822 may transmit consumer auth resp to the consumer 820. Further, at 808 of the method 800, the DW partner APIs 822 may transmit DW partner auth notification to PayDN APIs 828. Further, at 810 of the method 800, the PayDN APIs 828 may transmit PayDN auth match response to the DW partner APIs 822. Further, at 812 of the method 800, the merchant eCommerce website 830 may transmit merchant auth req to the PayDN APIs 828. Further, at 814 of the method 800, the PayDN APIs 828 may transmit merchant auth resp to the merchant eCommerce website 830. Further, at 816 of the method 800, the consumer 820 may transmit consumer transaction history inquiry to the DW partner APIs 822. Further, the DW partner APIs 822 may be communicatively coupled with a DW partner DB 824. Further, the PayDN APIs 828 may be communicatively coupled with a PayDN DB 826. PayDN can integrate with merchant eCom site or host directly. Basic transaction flow and process remains unchanged. This transaction context also supports the use of a simple transaction code (short string) instead of a QR code to simplify the user experience.

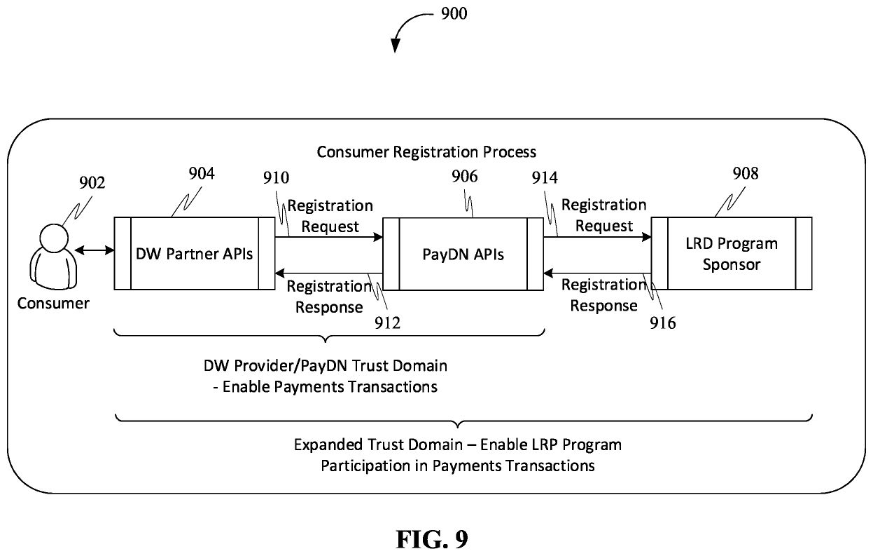

FIG. 9 is a flow diagram of a method 900 for registering customers for LRD programs, in accordance with some embodiments. Further, a consumer 902 may communicate with DW partner APIs 904. Further, at 910 of the method 900, the DW partner APIs may transmit a registration request to PayDN APIs 906. Further, at 912 of the method 900, the PayDN APIs may transmit a registration response to the DW partner APIs. Further, at 914 of the method 900, the PayDN APIs 906 may transmit the registration request to LRD program sponsor 908. Further, at 916 of the method 900, the LRD program sponsor may transmit the registration response to the PayDN APIs 906.

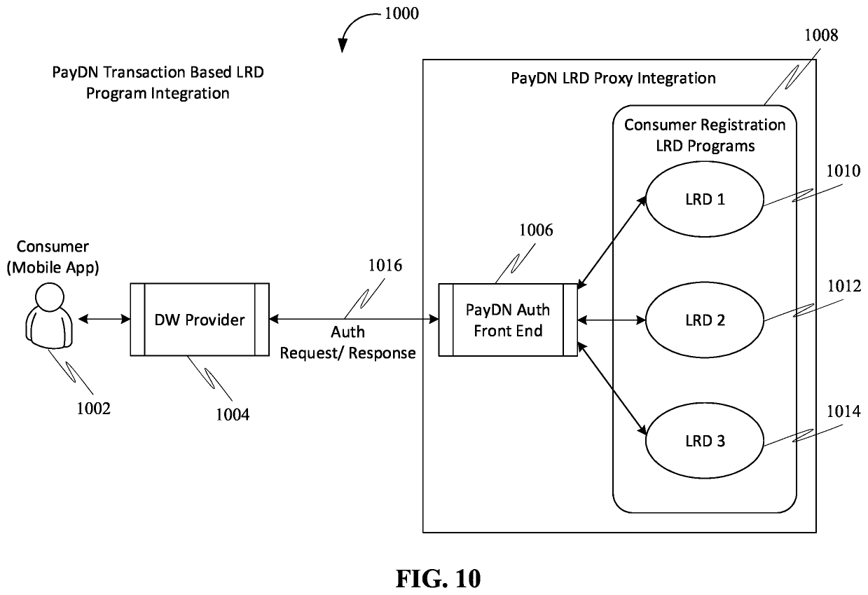

FIG. 10 is a flow diagram of a method 1000 for providing the LRD Programs as part of a transaction, in accordance with some embodiments. Further, a consumer 1002 may communicate with DW provider 1004. Further, at 1016 of the method 1000, the DW provider 1004 may transmit auth request/response to PayDN auth front end 1006. Further, the PayDN auth front end 1006 may communicate with consumer registration LRD programs 1008. Further, the consumer registration LRD programs 1008 may include LRD 1 1010, LRD 2 1012, and LRD 3 1014.

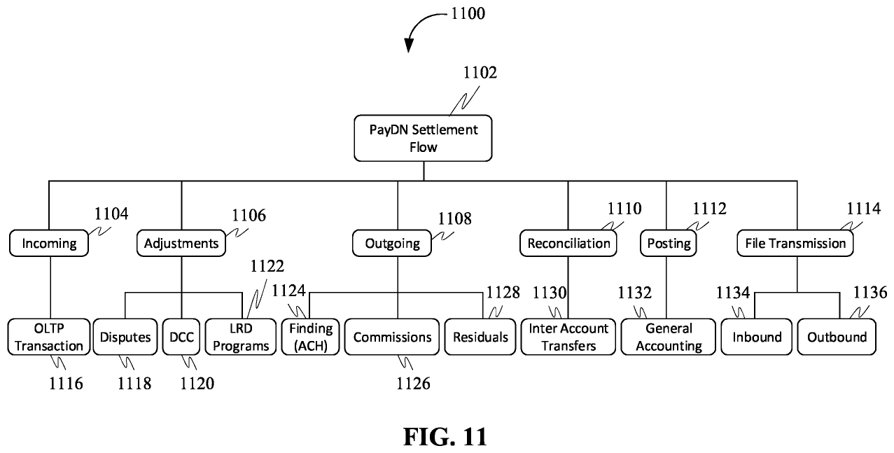

FIG. 11 is a flow diagram of a method 1100 for providing the LRD Programs as part of a settlement, in accordance with some embodiments. Further, the method 1100 may include a PayDN settlement flow 1102. Further, the PayDN settlement flow 1102 may include incoming 1104, adjustments 1106, outgoing 1108, reconciliation 1110, posting 1112, and file transmission 1114. Further, the incoming 1104 may include OLTP transaction 1116. Further, the adjustments 1106 may include disputes 1118, DCC 1120, and LRD programs 1122. Further, the outgoing 1108 may include finding (ACH) 1124, commissions 1126, and residuals 1128. Further, the reconciliation 1110 may include inter account transfers 1130. Further, the posting 1112 may include general accounting 1132. Further, the file transmission 1114 may include inbound 1134 and outbound 1136.

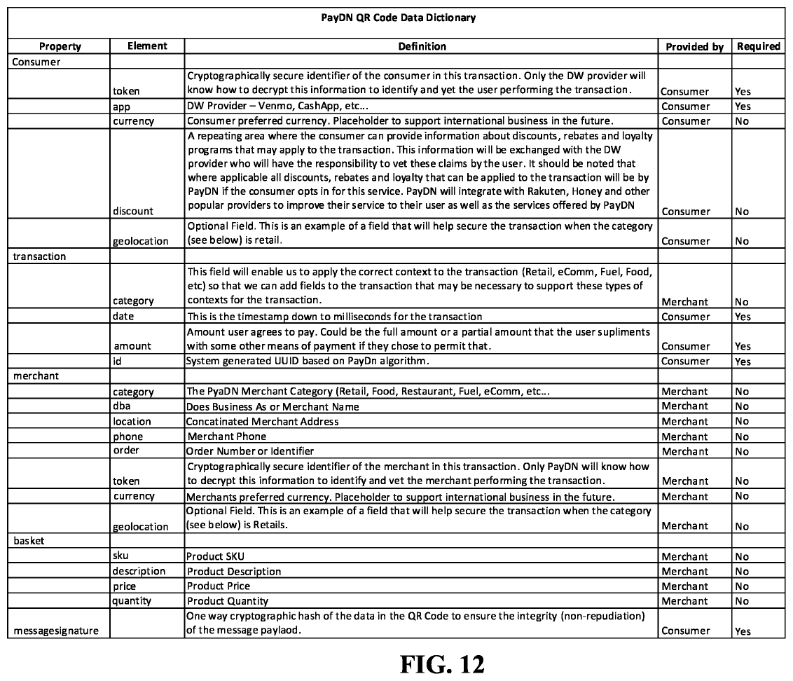

FIG. 12 illustrates a first data dictionary of PayDN, in accordance with some embodiments.

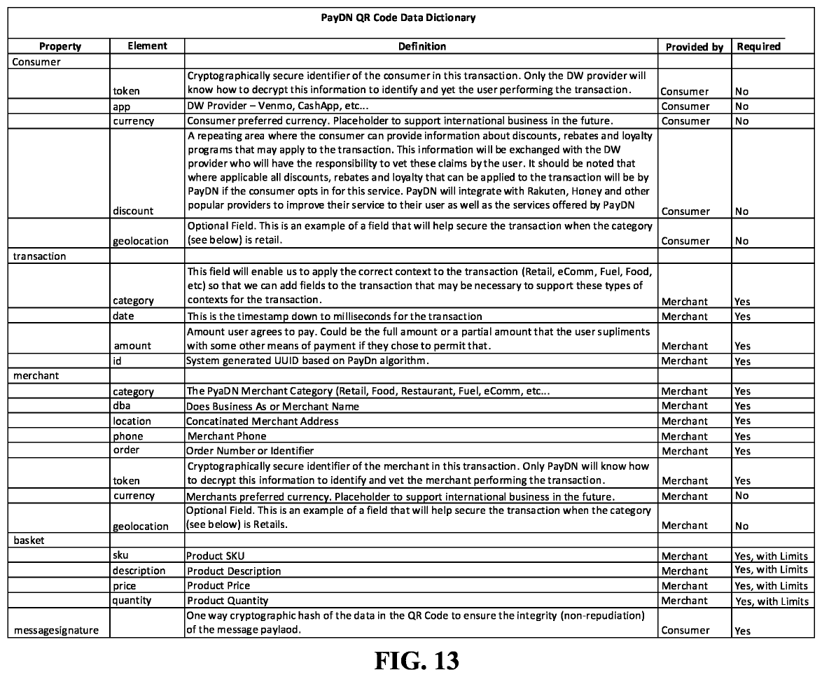

FIG. 13 illustrates a second data dictionary of the PayDN, in accordance with some embodiments.

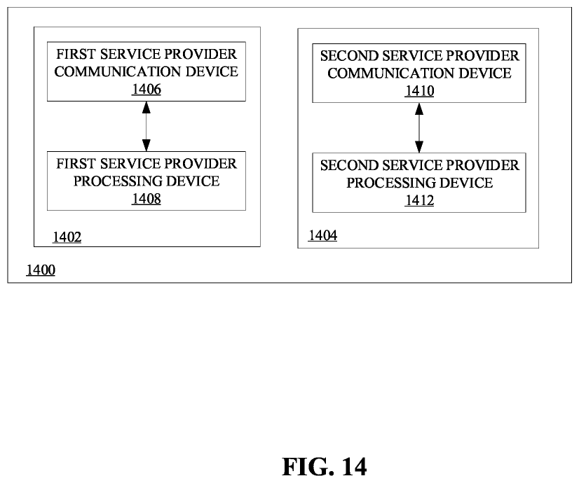

FIG. 14 is a block diagram of a system 1400 for facilitating secure payment transactions between users, in accordance with some embodiments. Accordingly, the system 1400 may include a first service provider device 1402 and a second service provider device 1404.

Further, the first service provider device 1402 associated with a first service provider may include a first service provider communication device 1406 and a first service provider processing device 1408.

Further, the first service provider communication device 1406 may be configured for receiving a first user authorization request for a payment transaction from a first user device associated with a first user. Further, the first service provider communication device 1406 may be configured for transmitting a first service provider authorization notification to the second service provider device 1404. Further, the first service provider communication device 1406 may be configured for receiving a second service provider authorization match response from the second service provider device 1404. Further, the first service provider communication device 1406 may be configured for transmitting a first user authorization response to the first user device. Further, the first service provider processing device 1408 may be communicatively coupled with the first service provider communication device 1406. Further, the first service provider processing device 1408 may be configured for analyzing the first user authorization request. Further, the first service provider processing device 1408 may be configured for generating the first service provider authorization notification based on the analyzing of the first user authorization request. Further, the first service provider processing device 1408 may be configured for generating the first user authorization response for the payment transaction based on the second service provider authorization match response.

Further, the second service provider device 1404 associated with a second service provider may include a second service provider communication device 1410 and a second service provider processing device 1412.

Further, the second service provider communication device 1410 may be configured for receiving a second user authorization request for the payment transaction from a second user device associated with a second user. Further, the second service provider communication device 1410 may be configured for receiving the first service provider authorization notification from the first service provider device 1402. Further, the second service provider communication device 1410 may be configured for transmitting the second service provider authorization match response to the first service provider device 1402. Further, the second service provider communication device 1410 may be configured for transmitting a second user authorization response to the second user device. Further, the second service provider processing device 1412 may be communicatively coupled with the second service provider communication device 1410. Further, the second service provider processing device 1412 may be configured for analyzing the second user authorization request and the first service provider authorization notification. Further, the second service provider processing device 1412 may be configured for determining a match between the second user authorization request and the first service provider authorization notification based on the analyzing of the second user authorization request and the first service provider authorization notification. Further, the second service provider processing device 1412 may be configured for generating the second service provider authorization match response for authenticating the payment transaction based on the analyzing of the second user authorization request and the first service provider authorization notification and the determining of the match. Further, the second service provider processing device 1412 may be configured for generating the second user authorization response for the payment transaction based on the second service provider authorization match response.

Further, in some embodiments, the first user device may include a first user communication device and a first user processing device. Further, the first user communication device may be configured for receiving a payment transaction code for the payment transaction from the second user device. Further, the first user communication device may be configured for transmitting at least one payment information to at least one first output device. Further, the first user communication device may be configured for receiving a first user acknowledgment from at least one first input device. Further, the first user communication device may be configured for transmitting the first user authorization request to the first service provider device 1402. Further, the first user processing device may be communicatively coupled with the first user communication device. Further, the first user processing device may be configured for analyzing the payment transaction code. Further, the first user processing device may be configured for generating the at least one payment information of the payment transaction based on the analyzing of the payment transaction code. Further, the first user processing device may be configured for generating the first user authorization request based on the analyzing of the payment transaction code and the first user acknowledgment.

Further, in an embodiment, the second user device may include a second user communication device and a second user processing device. Further, the second user communication device may be configured for receiving at least one payment transaction information associated with the payment transaction from at least one second input device. Further, the second user communication device may be configured for transmitting the payment transaction code to the first user device. Further, the second user processing device may be communicatively coupled with the second user communication device. Further, the second user processing device may be configured for analyzing the at least one payment transaction information. Further, the second user processing device may be configured for generating the payment transaction code based on the analyzing of the at least one payment transaction information.

Further, in an embodiment, the second user processing device may be configured for generating the second user authorization request based on the generating of the payment transaction code. Further, the second user communication device may be configured for transmitting the second user authorization request to the second service provider device 1404.

Further, in some embodiments, the first user device may include at least one first output device. Further, the at least one first output device may be configured for displaying the first user authorization response. Further, the second user device may include at least one second output device. Further, the at least one second output device may be configured for displaying the second user authorization response.

Further, in some embodiments, the first service provider communication device 1406 may be configured for receiving at least one benefit program request for availing at least one benefit program (LRD programs) for the payment transaction from the first user device. Further, the first service provider communication device 1406 may be configured for transmitting at least one unique token identifier associated with the first user to the second service provider device 1404. Further, the first service provider processing device 1408 may be configured for analyzing the at least one benefit program request. Further, the first service provider processing device 1408 may be configured for registering the first user for the at least one benefit program based on the analyzing of the at least one benefit program request. Further, the first service provider processing device 1408 may be configured for generating the at least one unique token identifier of at least one token assigned to the first user based on the registering. Further, the first service provider device 1402 may include a first service provider storage device communicatively coupled with the first service provider processing device 1408. Further, the first service provider storage device may be configured for storing the at least one unique token identifier associated with the first user.

Further, in an embodiment, the second service provider communication device 1410 may be configured for receiving a plurality of benefit programs provided by a benefit provider from a benefit provider device associated with the benefit provider. Further, the second service provider communication device 1410 may be configured for receiving the at least one unique token identifier from the first service provider device 1402. Further, the second service provider communication device 1410 may be configured for transmitting the at least one unique token identifier and at least one benefit program notification to the benefit provider device. Further, the second service provider processing device 1412 may be configured for analyzing the plurality of benefit programs and the at least one unique token identifier. Further, the second service provider processing device 1412 may be configured for identifying at least one benefit program from the plurality of benefit programs needed by the first user corresponding to the at least one token based on the analyzing of the plurality of benefit programs and the at least one unique token identifier. Further, the second service provider processing device 1412 may be configured for generating the at least one benefit program notification associated with the at least one benefit program based on the identifying.

Further, in an embodiment, the benefit provider device may include a benefit provider storage device, a benefit provider processing device, and a benefit provider communication device. Further, the benefit provider communication device may be configured for receiving the at least one unique token identifier and the at least one benefit program notification from the second service provider device 1404. Further, the benefit provider communication device may be configured for transmitting a registration response to the second service provider device 1404. Further, the benefit provider processing device communicatively coupled with the benefit provider communication device. Further, the benefit provider processing device may be configured for mapping the at least one token to the at least one benefit program. Further, the benefit provider processing device may be configured for generating the registration response for the first user based on the mapping. Further, the benefit provider storage device may be communicatively coupled with the benefit provider processing device. Further, the benefit provider storage device may be configured for storing the plurality of benefit programs.

Further, in some embodiments, the second service provider processing device 1412 may be configured for processing the payment transaction between the first user and the second user based on the authenticating. Further, the second service provider processing device 1412 may be configured for generating at least one payment transaction information associated with the payment transaction based on the processing.

Further, in an embodiment, the first user authorization request may include the at least one unique token identifier associated with the first user. Further, the first service provider processing device 1408 may be configured for identifying the at least one benefit program appliable to the first user based on the analyzing of the first user authorization request. Further, the first service provider communication device 1406 may be configured for transmitting the at least one token and the at least one benefit program to the second service provider device 1404. Further, the second service provider communication device 1410 may be configured for receiving the at least one token and the at least one benefit program. Further, the second service provider communication device 1410 may be configured for transmitting at least one link to the benefit provider device. Further, the second service provider communication device 1410 may be configured for receiving at least one response on the at least one link from the benefit provider device. Further, the second service provider processing device 1412 may be configured for analyzing the at least one benefit program and the at least one payment transaction information. Further, the second service provider processing device 1412 may be configured for establishing the at least one link between the at least one transaction information and the at least one benefit program based on the analyzing of the at least one benefit program and the at least one payment transaction information. Further, the second service provider processing device 1412 may be configured for analyzing the at least one response. Further, the second service provider processing device 1412 may be configured for updating the payment transaction based on the analyzing of the at least one response.

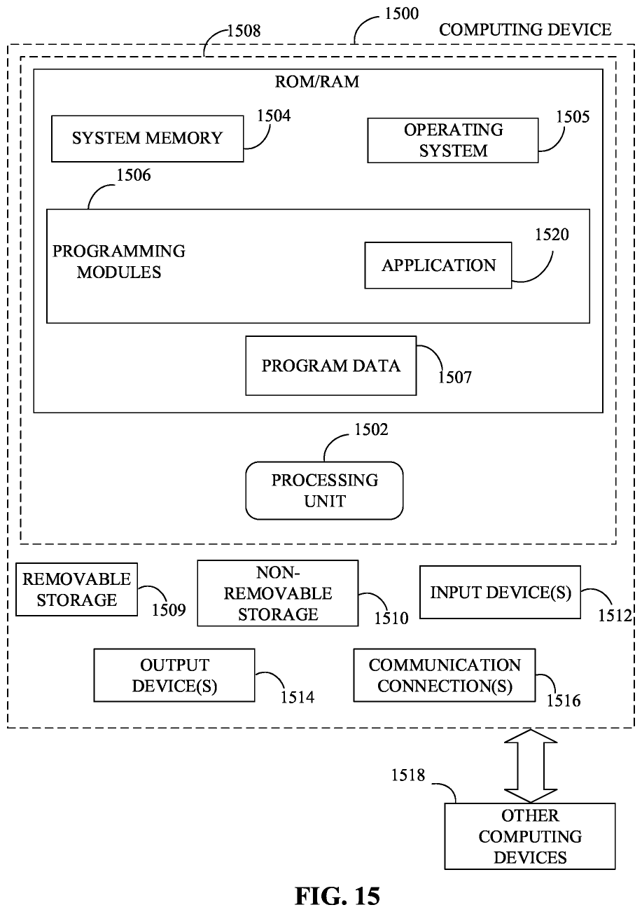

With reference to FIG. 15, a system consistent with an embodiment of the disclosure may include a computing device or cloud service, such as computing device 1500. In a basic configuration, computing device 1500 may include at least one processing unit 1502 and a system memory 1504. Depending on the configuration and type of computing device, system memory 1504 may comprise, but is not limited to, volatile (e.g. random-access memory (RAM)), non-volatile (e.g. read-only memory (ROM)), flash memory, or any combination. System memory 1504 may include operating system 1505, one or more programming modules 1506, and may include a program data 1507. Operating system 1505, for example, may be suitable for controlling computing device 1500's operation. In one embodiment, programming modules 1506 may include image-processing module, machine learning module. Furthermore, embodiments of the disclosure may be practiced in conjunction with a graphics library, other operating systems, or any other application program and is not limited to any particular application or system. This basic configuration is illustrated in FIG. 15 by those components within a dashed line 1508.

Computing device 1500 may have additional features or functionality. For example, computing device 1500 may also include additional data storage devices (removable and/or non-removable) such as, for example, magnetic disks, optical disks, or tape. Such additional storage is illustrated in FIG. 15 by a removable storage 1509 and a non-removable storage 1510. Computer storage media may include volatile and non-volatile, removable and non-removable media implemented in any method or technology for storage of information, such as computer-readable instructions, data structures, program modules, or other data. System memory 1504, removable storage 1509, and non-removable storage 1510 are all computer storage media examples (i.e., memory storage). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1500. Any such computer storage media may be part of device 1500. Computing device 1500 may also have input device(s) 1512 such as a keyboard, a mouse, a pen, a sound input device, a touch input device, a location sensor, a camera, a biometric sensor, etc. Output device(s) 1514 such as a display, speakers, a printer, etc. may also be included. The aforementioned devices are examples and others may be used.

Computing device 1500 may also contain a communication connection 1516 that may allow device 1500 to communicate with other computing devices 1518, such as over a network in a distributed computing environment, for example, an intranet or the Internet. Communication connection 1516 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1504, including operating system 1505. While executing on processing unit 1502, programming modules 1506 (e.g., application 1520 such as a media player) may perform processes including, for example, one or more stages of methods, algorithms, systems, applications, servers, databases as described above. The aforementioned process is an example, and processing unit 1502 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A system for facilitating secure payment transactions between users, the system comprising:
a first service provider device associated with a first service provider comprising:
a first service provider communication device configured for:
receiving a first user authorization request for a payment transaction from a first user device associated with a first user;
transmitting a first service provider authorization notification to a second service provider device;
receiving a second service provider authorization match response from the second service provider device; and
transmitting a first user authorization response to the first user device; and
a first service provider processing device communicatively coupled with the first service provider communication device, wherein the first service provider processing device is configured for:
analyzing the first user authorization request;
generating the first service provider authorization notification based on the analyzing of the first user authorization request; and
generating the first user authorization response for the payment transaction based on the second service provider authorization match response; and
the second service provider device associated with a second service provider comprising:
a second service provider communication device configured for:
receiving a second user authorization request for the payment transaction from a second user device associated with a second user;
receiving the first service provider authorization notification from the first service provider device;
transmitting the second service provider authorization match response to the first service provider device; and
transmitting a second user authorization response to the second user device; and
a second service provider processing device communicatively coupled with the second service provider communication device, wherein the second service provider processing device is configured for:
analyzing the second user authorization request and the first service provider authorization notification;
generating the second service provider authorization match response for authenticating the payment transaction based on the analyzing of the second user authorization request and the first service provider authorization notification; and
generating the second user authorization response for the payment transaction based on the second service provider authorization match response.

2. The system of claim 1, wherein the first user device comprises a first user communication device and a first user processing device, wherein the first user communication device is configured for:
receiving a payment transaction code for the payment transaction from the second user device;
transmitting at least one payment information to at least one first output device;
receiving a first user acknowledgment from at least one first input device; and
transmitting the first user authorization request to the first service provider device, wherein the first user processing device is communicatively coupled with the first user communication device, wherein the first user processing device is configured for:
analyzing the payment transaction code;
generating the at least one payment information of the payment transaction based on the analyzing of the payment transaction code; and
generating the first user authorization request based on the analyzing of the payment transaction code and the first user acknowledgment.

3. The system of claim 2, wherein the second user device comprises a second user communication device and a second user processing device, wherein the second user communication device is configured for:
receiving at least one payment transaction information associated with the payment transaction from at least one second input device;
transmitting the payment transaction code to the first user device, wherein the second user processing device is communicatively coupled with the second user communication device, wherein the second user processing device is configured for:
analyzing the at least one payment transaction information; and
generating the payment transaction code based on the analyzing of the at least one payment transaction information.

4. The system of claim 3, wherein the second user processing device is further configured for generating the second user authorization request based on the generating of the payment transaction code, wherein the second user communication device is further configured for transmitting the second user authorization request to the second service provider device.

5. The system of claim 1, wherein the second service provider processing device is further configured for determining a match between the second user authorization request and the first service provider authorization notification based on the analyzing of the second user authorization request and the first service provider authorization notification, wherein the generating of the second service provider authorization match response is further based on the determining the match.

6. The system of claim 1, wherein the first user device comprises at least one first output device, wherein the at least one first output device is configured for displaying the first user authorization response, wherein the second user device comprises at least one second output device, wherein the at least one second output device is configured for displaying the second user authorization response.

7. The system of claim 1, wherein the first service provider communication device is further configured for:
receiving at least one benefit program request for availing at least one benefit program for the payment transaction from the first user device; and
transmitting at least one unique token identifier associated with the first user to the second service provider device, wherein the first service provider processing device is further configured for:
analyzing the at least one benefit program request;
registering the first user for the at least one benefit program based on the analyzing of the at least one benefit program request; and
generating the at least one unique token identifier of at least one token assigned to the first user based on the registering, wherein the first service provider device comprises a first service provider storage device communicatively coupled with the first service provider processing device, wherein the first service provider storage device is configured for storing the at least one unique token identifier associated with the first user.

8. The system of claim 7, wherein the second service provider communication device is further configured for:
receiving a plurality of benefit programs provided by a benefit provider from a benefit provider device associated with the benefit provider;
receiving the at least one unique token identifier from the first service provider device; and
transmitting the at least one unique token identifier and at least one benefit program notification to the benefit provider device, wherein the second service provider processing device is further configured for:
analyzing the plurality of benefit programs and the at least one unique token identifier;
identifying at least one benefit program from the plurality of benefit programs needed by the first user corresponding to the at least one token based on the analyzing of the plurality of benefit programs and the at least one unique token identifier; and
generating the at least one benefit program notification associated with the at least one benefit program based on the identifying.

9. The system of claim 8, wherein the benefit provider device comprises a benefit provider storage device, a benefit provider processing device, and a benefit provider communication device, wherein the benefit provider communication device is configured for:
receiving the at least one unique token identifier and the at least one benefit program notification from the second service provider device;
transmitting a registration response to the second service provider device, wherein the benefit provider processing device communicatively coupled with the benefit provider communication device, wherein the benefit provider processing device is configured for:
mapping the at least one token to the at least one benefit program; and
generating the registration response for the first user based on the mapping, wherein the benefit provider storage device is communicatively coupled with the benefit provider processing device, wherein the benefit provider storage device is configured for storing the plurality of benefit programs.

10. The system of claim 9, wherein the second service provider processing device is further configured for:
processing the payment transaction between the first user and the second user based on the authenticating; and
generating at least one payment transaction information associated with the payment transaction based on the processing.

11. The system of claim 10, wherein the first user authorization request comprises the at least one unique token identifier associated with the first user, wherein the first service provider processing device is further configured for identifying the at least one benefit program appliable to the first user based on the analyzing of the first user authorization request, wherein the first service provider communication device is further configured for transmitting the at least one token and the at least one benefit program to the second service provider device, wherein the second service provider communication device is further configured for:
receiving the at least one token and the at least one benefit program;
transmitting at least one link to the benefit provider device; and
receiving at least one response on the at least one link from the benefit provider device, wherein the second service provider processing device is further configured for:
analyzing the at least one benefit program and the at least one payment transaction information;
establishing the at least one link between the at least one transaction information and the at least one benefit program based on the analyzing of the at least one benefit program and the at least one payment transaction information;
analyzing the at least one response; and
updating the payment transaction based on the analyzing of the at least one response.

12. A system for facilitating secure payment transactions between users, the system comprising:
a first service provider device associated with a first service provider comprising:
a first service provider communication device configured for:
receiving a first user authorization request for a payment transaction from a first user device associated with a first user;
transmitting a first service provider authorization notification to a second service provider device;
receiving a second service provider authorization match response from the second service provider device; and
transmitting a first user authorization response to the first user device; and
a first service provider processing device communicatively coupled with the first service provider communication device, wherein the first service provider processing device is configured for:
analyzing the first user authorization request;
generating the first service provider authorization notification based on the analyzing of the first user authorization request; and
generating the first user authorization response for the payment transaction based on the second service provider authorization match response; and
the second service provider device associated with a second service provider comprising:
a second service provider communication device configured for:
receiving a second user authorization request for the payment transaction from a second user device associated with a second user;
receiving the first service provider authorization notification from the first service provider device;
transmitting the second service provider authorization match response to the first service provider device; and
transmitting a second user authorization response to the second user device; and
a second service provider processing device communicatively coupled with the second service provider communication device, wherein the second service provider processing device is configured for:
analyzing the second user authorization request and the first service provider authorization notification;
determining a match between the second user authorization request and the first service provider authorization notification based on the analyzing of the second user authorization request and the first service provider authorization notification;
generating the second service provider authorization match response for authenticating the payment transaction based on the analyzing of the second user authorization request and the first service provider authorization notification and the determining of the match; and
generating the second user authorization response for the payment transaction based on the second service provider authorization match response.

13. The system of claim 12, wherein the first user device comprises a first user communication device and a first user processing device, wherein the first user communication device is configured for:
receiving a payment transaction code for the payment transaction from the second user device;
transmitting at least one payment information to at least one first output device;
receiving a first user acknowledgment from at least one first input device; and
transmitting the first user authorization request to the first service provider device, wherein the first user processing device is communicatively coupled with the first user communication device, wherein the first user processing device is configured for:
analyzing the payment transaction code;
generating the at least one payment information of the payment transaction based on the analyzing of the payment transaction code; and
generating the first user authorization request based on the analyzing of the payment transaction code and the first user acknowledgment.

14. The system of claim 13, wherein the second user device comprises a second user communication device and a second user processing device, wherein the second user communication device is configured for:
receiving at least one payment transaction information associated with the payment transaction from at least one second input device;
transmitting the payment transaction code to the first user device, wherein the second user processing device is communicatively coupled with the second user communication device, wherein the second user processing device is configured for:
analyzing the at least one payment transaction information; and
generating the payment transaction code based on the analyzing of the at least one payment transaction information.

15. The system of claim 14, wherein the second user processing device is further configured for generating the second user authorization request based on the generating of the payment transaction code, wherein the second user communication device is further configured for transmitting the second user authorization request to the second service provider device.

16. The system of claim 12, wherein the first service provider communication device is further configured for:
receiving at least one benefit program request for availing at least one benefit program for the payment transaction from the first user device; and
transmitting at least one unique token identifier associated with the first user to the second service provider device, wherein the first service provider processing device is further configured for:
analyzing the at least one benefit program request;
registering the first user for the at least one benefit program based on the analyzing of the at least one benefit program request; and
generating the at least one unique token identifier of at least one token assigned to the first user based on the registering, wherein the first service provider device comprises a first service provider storage device communicatively coupled with the first service provider processing device, wherein the first service provider storage device is configured for storing the at least one unique token identifier associated with the first user.

17. The system of claim 16, wherein the second service provider communication device is further configured for:
receiving a plurality of benefit programs provided by a benefit provider from a benefit provider device associated with the benefit provider;
receiving the at least one unique token identifier from the first service provider device; and
transmitting the at least one unique token identifier and at least one benefit program notification to the benefit provider device, wherein the second service provider processing device is further configured for:
analyzing the plurality of benefit programs and the at least one unique token identifier;
identifying at least one benefit program from the plurality of benefit programs needed by the first user corresponding to the at least one token based on the analyzing of the plurality of benefit programs and the at least one unique token identifier; and
generating the at least one benefit program notification associated with the at least one benefit program based on the identifying.

18. The system of claim 17, wherein the benefit provider device comprises a benefit provider storage device, a benefit provider processing device, and a benefit provider communication device, wherein the benefit provider communication device is configured for:
receiving the at least one unique token identifier and the at least one benefit program notification from the second service provider device;
transmitting a registration response to the second service provider device, wherein the benefit provider processing device communicatively coupled with the benefit provider communication device, wherein the benefit provider processing device is configured for:
mapping the at least one token to the at least one benefit program; and
generating the registration response for the first user based on the mapping, wherein the benefit provider storage device is communicatively coupled with the benefit provider processing device, wherein the benefit provider storage device is configured for storing the plurality of benefit programs.

19. The system of claim 18, wherein the second service provider processing device is further configured for:
processing the payment transaction between the first user and the second user based on the authenticating; and
generating at least one payment transaction information associated with the payment transaction based on the processing.

20. The system of claim 19, wherein the first user authorization request comprises the at least one unique token identifier associated with the first user, wherein the first service provider processing device is further configured for identifying the at least one benefit program appliable to the first user based on the analyzing of the first user authorization request, wherein the first service provider communication device is further configured for transmitting the at least one token and the at least one benefit program to the second service provider device, wherein the second service provider communication device is further configured for:
receiving the at least one token and the at least one benefit program;
transmitting at least one link to the benefit provider device; and
receiving at least one response on the at least one link from the benefit provider device, wherein the second service provider processing device is further configured for:
analyzing the at least one benefit program and the at least one payment transaction information;
establishing the at least one link between the at least one transaction information and the at least one benefit program based on the analyzing of the at least one benefit program and the at least one payment transaction information;
analyzing the at least one response; and
updating the payment transaction based on the analyzing of the at least one response.
